(19) United States
(12) Patent Application Publication
(10) Pub. No.: US 2005/0160141 A1
(43) Pub. Date: Jul. 21, 2005

(54) Internet network banner

(76) Inventors: Mark Galley, Westport, CT (US); Rory Braithwaite, Flushing, NY (US); Melissa Martinez, Ridgefield, CT (US); Laura Hurwitz, Bridgeport, CT (US)

Correspondence Address: Andrew S. Reiskind;Modem Media, Inc., 230 East Avenue, Norwalk, CT, 06855, US

(21) Appl. No.: 10/761,973

(22) Filed: Jan. 21, 2004

(51) Int. Cl. G06F 15/16

(52) U.S. Cl. 709/204; 709/201

(57) ABSTRACT

The present invention relates to network banners which are distinct software applications embedded within a web page or other internet application, which banners are capable of sending and receiving data via the internet from a central synchronization server. Such communication may be done without the user's leaving the web page wherein the network banner is embedded. The network banners enable real time communications between and among distinct computers and users connected to the internet. The network banners may include gaming functionalities for multi-party gaming among network banners or communications software.

### FIELD

This invention relates to networking internet users together in a “banner ad” or other media distributed entry points. More particularly, this invention provides the process and architecture used to connect these users.

### BACKGROUND OF THE INVENTION

The architecture of the internet (or “Web”) follows a conventional client-server model. The terms “client” and “server” are used to refer to a computer's general role as a requester of data (the client) or provider of data (the server). Web browsers reside in clients and specially formatted “Web documents” reside on Internet (Web) servers. Web clients and Web servers communicate using a protocol called “HyperText Transfer Protocol” (HTTP). In operation, a browser opens a connection to a server and initiates a request for a document or a Web page including content. The server delivers the requested document or Web page, typically in the form coded in a standard “HyperText Markup Language” (HTML) format. After the document or Web page is delivered, the connection is closed and the browser displays the document or Web page to the user.

The Internet consists of a worldwide computer network that communicates using well defined protocol known as the Internet Protocol (IP). To access a document on the Web, the user enters a URL for the Web document into a browser program executing on a client system with a connection to the Internet. The Web browser then sends a request in accordance with the HTTP protocol to the Web server that has the Web document using the URL. The Web server responds to the request by transmitting the requested object to the client. Such objects often contain hyperlinks to other Web documents. Generally, users view the content delivered in the Web pages and may select hyperlinks to other sub pages of a Web site, or to entirely different Web sites.

The internet is an advertising supported medium, wherein publishers sell advertising “space” on their web site to third parties in what are referred to as banner ads. These banners may be delivered to the user by the Web page's provider, or may be provided by a third party advertisement server. When an interested user selects the advertisement (by “clicking through” on the banner) the user is generally forwarded to another Web page or site associated with the advertisement.

The use of banner ads to deliver interactive functionality is previously known, see, e.g., U.S. Pat. No. 6,379,251. In that case, the user interactive banner ad is delivered through the interaction of a client computer with a web server and an ad server. In that process, a user's computer first transmits a first URL request to a web server. The user's computer subsequently receives web page data from the web server. The web page data includes banner ad data that identifies the source of one or more components (e.g., text, graphic image data, applet executable code, etc.) to be used in rendering a banner ad in the web page defined by the web page data. The user's computer retrieves the components by transmitting a second URL request to an ad server. If the source of the components is applet executable code (e.g., Java applet), then the user's computer receives computer program logic for storage on a computer usable medium in the user's computer. The computer program logic generally includes a means for enabling a processor in the user's computer to implement the user interactive gaming function within a portion of the banner ad. The click-through process can be integrated with the user actions that are carried out in a user interactive area of the banner ad. Prior to the present invention, the interactivity of banner ads has been limited to interactivity with software, not with other people.

Additionally, users have grown accustomed to interacting with other users via web site-oriented means that include: chat rooms, games, learning sessions, brand promotional activities, and other destination-oriented utilities. Prior to the present invention, one commonality through it all is that any Users wishing to participate in such activities must first go to a given destination web site to engage in such activity and could not do so within a banner ad.

Examples of prior art interactive utilities include U.S. Pat. Nos. 5,586,257 and 5,899,810 relating to reducing lag time so as to allow for “real-time” gaming between individuals, and U.S. Pat. No. 5,695,400 relating to managing multi-person interactions but none of these have contemplated utility within a banner ad, but utility solely within the context of the destination site.

All referenced prior art is hereby incorporated by reference.

### SUMMARY OF THE INVENTION

This invention relates to the process and architecture of joining internet users together in a real-time, multi-user scenario accessed through an “internet banner” or other similar media-placed units within another web page or window (hereinafter referred to as “Network Banners”). The present invention allows users when surfing their favorites sites, to interact with others without having to disrupt their internet experience or be dependent on any one property to achieve that goal. The result of the present invention is that multiple users are interacting with or against each other to achieve a certain goal (either jointly or individually.) The structure and functionality of these interactions are broad and could include: gaming, chat, promotional fulfillment, and interaction with brand representatives or “hosts.” The interaction being users can be a one-to-one relationship, a one-to-many, or a many-to-many. The users can be “joined” together so that they can collaborate, share information, compete against one another, or ask questions of each other.

The interactions between the users will be managed and distributed using a central server for synchronization. If an action by one user is designed to affect the experience of other users, the synchronization server will update the interface of the latter users and vice versa. All interactions between the users will be routed through the synchronization server.

### BRIEF DESCRIPTION OF THE DRAWINGS

FIG. 1 is a flow chart of the usage of the Network Banner by two users.

FIG. 2 is the synchronization process by which Network Banners among multiple users are synchronized.

FIG. 3 is a flow showing actions among Users, the Network Banners and the servers.

FIG. 4 is an example of a how multiple users interact with the Network Banners.

FIG. 5 is User Experience using the Network Banners.

FIG. 6 is a depiction of an example.

### DETAILED DESCRIPTION OF THE INVENTION

The Network Banners appear to the internet user as standard banner advertisements on web pages or certain applications. Depending on the particular functionality of the banner users can game, learn, align, or simply relate with each other purely by interacting with a unit that's already on the page they're on. This invention avoids the disadvantages of searching or leaving the particular web page on which the Network Banner is located. From a user point of view there is no experience disruption to their surfing based on their interaction with the Network Banner.

Through the Network Banners users are invited to participate in a unique internet-based network experience (promoted through any number of potential banner themes) and, upon doing so, are matched with other users who have chosen to do the same thing. Once the users have elected to participate in the activity (gaming, promotional, informative, etc.), depending on the activity the users are “grouped”, “teamed”, or “aligned against each other.” In users' use of the Network Banner, users do not leave the web page in which the Network Banner is embedded.

Banners in general are placements or “space” on a particular web page owned or operated by a first party which are purchased, exchanged for, bartered for, by a third party. The banners are distinct creative units or software code embedded within the main web (internet) page. For example Yahoo.com and ESPN.com sell space on their various web pages to different advertisers. Such spaces commonly are referred to as banner ads. The first party web site provides the means so the content from the third party (e.g., the banner) is provided as part of the first party's web page to a user when the user's browser calls that web page, e.g, the response to the call from user's browser to Yahoo.com includes a tag for the browser to make a call for that banner ad (whether the banner is located on Yahoo's servers or a third party adserver's servers) and that content is provided as part of the provision of the entire web page. To the user this multi-step process is generally seamless as is the distinction between first and third party content (unless specifically labeled).

Banners may also be space on certain distributed applications. For example if a user downloads a first party's presentation which is an executable file, such file may contain banner ads. The present invention would work in such distributed applications.

Network Banners are distributed media units with an executable logical code component (i.e., software). The banners include a presentation interface (i.e., the interface the user sees) and logical functionality (i.e., code) for a user to provide and receive data which is transmitted via the internet so that the user can interact with other users. The banner should be a self-contained unit that does not rely on the embedded web page for any input. Based on the size of the Network Banner file, some of the data required for the user interaction may be a component of the media unit or it may rely on the other external data.

The Network Banner may be coded in C, C++, Visual C, Java, or ActiveX plug-ins for an internet browser, preferably, Macromedia's software Flash. The building of the banner will be known to one of skill in the art. First, one plans the functionality of the banner application that will enable many users to interact in real time (e.g., planning a trivia game). The application should be built to allow the users to input data, actions, etc., and transmit this data to the server via the internet. The application must be configured to receive updates from the synchronization server and process the data accordingly.

The Network Banner should include a functionality commonly known as a sniffer which determines whether the necessary software (e.g., Flash) is loaded on the user's computer. Such a sniffer will prompt the user to download the necessary software if the software is not loaded on the user's computer.

The Network Banners may be of any size (pixel by pixel) but it is preferred that they be created in the industry's accepted sizes (468×60, 234×60, 88×31, 120×90, 120×60, 120×240, 125×125, 728×90, 160×600, and 120×600), for ease of placement. Banners may be of different sizes yet of the same functionality in which case such Banners may be connected for the purposes of this invention. Banners may also be made so that they are viewed initially as one of these sizes and then they have a pull down functionality so that they can be expanded by the user within the web page.

The Network Banner is made available for public use via embedding in another web document or other internet-based application. The web document or other internet-based publication will in general be a web page of a publisher on whom the Banner network developer has purchased media space, e.g., a banner advertisement on Yahoo.com.

Once a user using their internet browser visits a web page where there should be a Network Banner, the web page will include a tag for the user's internet browser to call the Network Banner. The provision of the Network Banner to the user's browser is delivered to the user's browser by a system that owns (i.e., the web publisher on whose web page the space was purchased) or has permission to place the units, such as a third party ad server (e.g., DoubleClick or Eyeblaster). The Network Banner will be downloaded on to the user's computer as part of such process.

Once a Network Banner is loaded on to a user's computer for execution by the user's browser, when a user interacts with the Network Banner, a request is sent via the internet from the user's browser to a synchronization server which creates a persistent connection between that server and the user's browser. There may be multiple synchronization servers for a particular Network Banner, but for interactions as between two or among a group of users, they must be on the same synchronization server. The user does not need to leave the current web page or application in order to interact with this server and preferably would not (i.e., the user's browser would not open a new window or change the browser window to a new URL). As various users interact with other Network Banners across the Internet, each user is given a unique identifier via the internet by the synchronization server that then is used to “match” them with other users. The synchronization server may match the users on a random basis, or allow for a user to select another user from a list of other available users. Alternatively, the Network Banner could have an e-mail or instant message functionality whereby the user invites another user known to that person.

The synchronization server should be programmed to enable multiple persistent connections or allows frequent access to a central data source by the individual, distributed network banners. All such connections are made via the internet. The synchronization server must be configured to receive data from the connected Network Banners, process the data according to the rules of the particular application (e.g., the rules of the game) and return data to the users, all using internet protocol.

A session on the synchronization server is created in which the matched users can interact via the internet through the Network Banner. As a second user, or further users enter this session, the synchronization server, based upon pre-defined requirements, keeps a record of data updated by each user's Network Banner. The synchronization server updates and distributes the data through the Network Banners periodically. During a session users will provide data via the Network Banner, which will transmit the data to the synchronization server. There is not a technical limit on the number of users able to interact, but the greater the number of users, the slower the application. The synchronization server will process the data according to the rules of the application (e.g., whether it is a right or wrong answer to a trivia question) and then provide such data back to the users via their Network Banners, i.e., synchronize the individual Network Banners.

From a process perspective, the Figures illustrate the steps users take in their use of the Network Banners, as well as data flow from the Network Banners to and from the synchronization server.

A simple example of this application would be a trivia challenge game. Once users are matched through the synchronization server, each Network Banner would prompt the users to indicate when they are ready to begin. When each user indicates readiness (through a click or other event-driven action), the Network Banner notifies the synchronization server that this user is ready. The other Network Banners in this session prompt their users for the same response. Each Network Banner continues to query the synchronization server to see if all users are ready. Once the Network Banner receives an affirmative to the query, it will present the first question to all players. When a user responds, the Network Banner will send the response to the synchronization server. The Network Banner will query the synchronization server to determine if all users responded. It will continue to query the synchronization server until all users have responded or until a time limit is reached. The data from the collective responses is retrieved from the synchronization server by the Network Banner and tabulated so that all users know how they rank among the other users.

The information that can be sent to and from the Network Banner to the synchronization server via the internet can take the form of text, audio (sound clip, e.g. music, spoken question, spoken answer), video (e.g. movie clip, video of a product or technique, live feed), user interactions (e.g. mouse movements, keystrokes, touch-screen), data via global positioning systems (GPS), or a culmination of the above in a complex interactive online gaming (e.g. games that are a similar caliber to massive multi-player online role playing games—MMORPS, sporting games, or real-time strategy games—RTS.)

Viral components can also be integrated into the network banners. These components include but are not limited to chat, instant messaging, and email. Integrating the viral capability will allow users to invite others to interact in the network.

In an alternative embodiment of the invention, the concept of network banners can extend itself to a multi-channel experience. Specifically, one user can be connected within the Network Banner while others enter the same network (i.e., same synchronization server) via a web site, kiosk, handheld device, phone, interactive television, CD, DVD, or downloadable application, which is connected to the internet. Such other device must have the same executable coding as is present in the Network Banner. Therefore, within the one-to-one relationship, one-to-many relationship, or many-to-many relationship, at least one user will be networked through the Network Banner. Network Banners are not limited to sites; networked banners can be distributed to handheld sites and interactive television as well.

The notion of networking users through distributed media units can be applied to numerous applications. The invention lends itself to other scenarios including but not limited to: (a) customer relationship management—live brand representatives waiting in a banner to consult with consumers, address their questions, and offer advice; (b) environmental interaction—grouping users together in visually themed environments such as a dating game in a bar or a tour in a virtual museum; (c) network-oriented offers—a banner offer that rewards users for certain synchronous actions; (d) digital editing—users can join in a banner to create, edit, or view music, art, videos, or other similar forms of media; (e) remote control—the media unit acts as the primary interface or “remote” in which the user or application could trigger internet based actions that could be launched and/or received by the media unit; (f) scavenger hunt—users can communicate with one another in the media unit and will be led to various sites by clues within the media unit; and (g) complex online gaming—integrating MMORPS, RTS, XBOX, and PlayStation caliber games with the media unit.

### DETAILED DESCRIPTION OF THE DRAWINGS

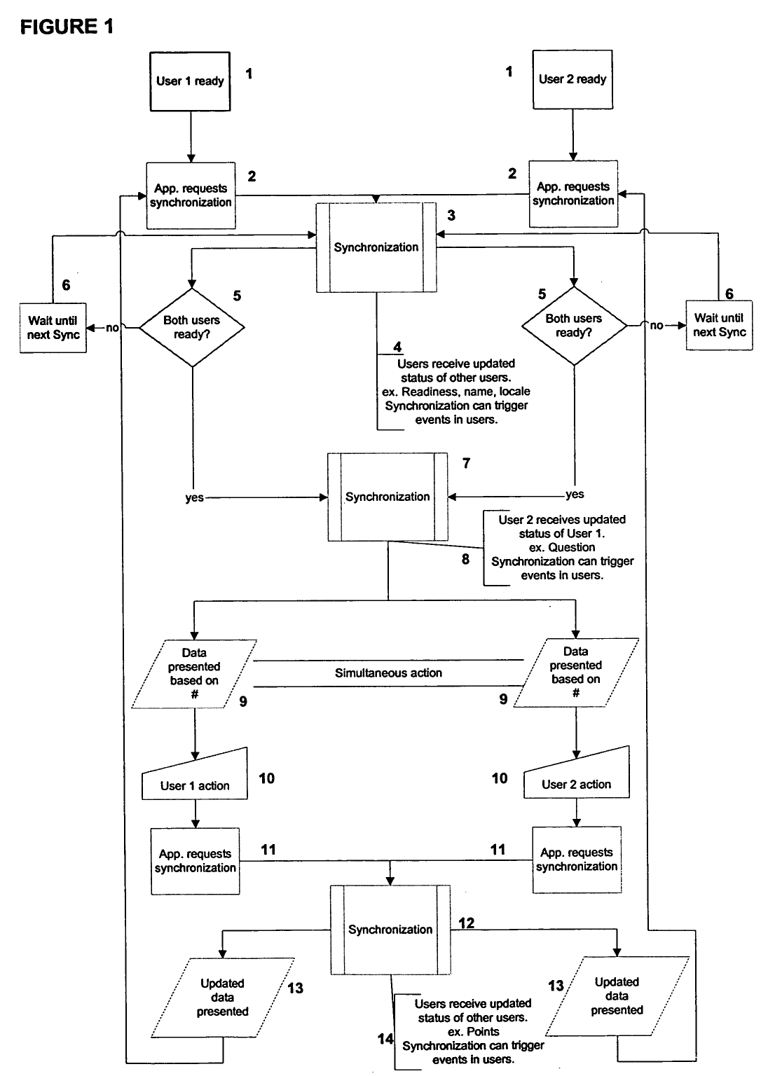

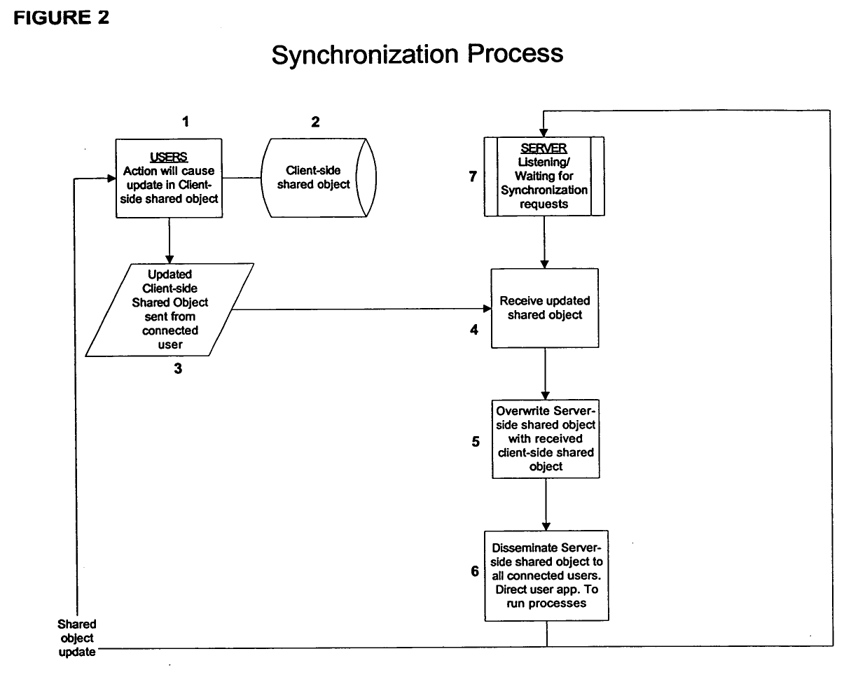

FIG. 1 is a flow diagram of the how the user interaction reaches the synchronization server through the distributed Network Banner. In steps 1, each User indicates via the Network Banner their readiness, usually by clicking a button. In steps 2, the Network Banner transmits this request to the synchronization server. In step 3 the synchronization server compares the data received from the users. In Step 4, the synchronization server provides data to the users regarding the other user's status and any other relevant information. In step 5, the synchronization server determines whether both users are ready. If both users are not ready, the process repeats (6) through the synchronization process (see FIG. 2). If both users are ready, the synchronization server in step 7 receives the data from User 1 and provides the synchronized data to user 2 step 8 In step 9 the synchronization server simultaneously provides the updated data to the two users. Each user may then take the appropriate action in step 10 in each program, e.g., answer a question in a trivia game. Each of these actions is then provided to the synchronization server in step 11 by the Network Banners. In step 12, the server synchronizes the data and then in step 13 presents updated data to the two users based on the data provided by the users. Additional functions may occur at this point in step 14, e.g., ending the game. If the process continues, it returns to step 2 and the process continues until the application is finished, e.g., the end of the game.

FIG. 2 is depiction of the synchronization process. In step 1, the users provide information to the client side object, i.e., the Network Banner. In step 3, this information is sent by the Network Banner to the synchronization server, which receives it in step 4. In Step 5, the server overwrites the old data and in step 6 distributes the new data with the users, which either repeats to Users' actions in Step 1 or to the synchronization server in Step 7 which is in listening mode waiting for actions by the Users.

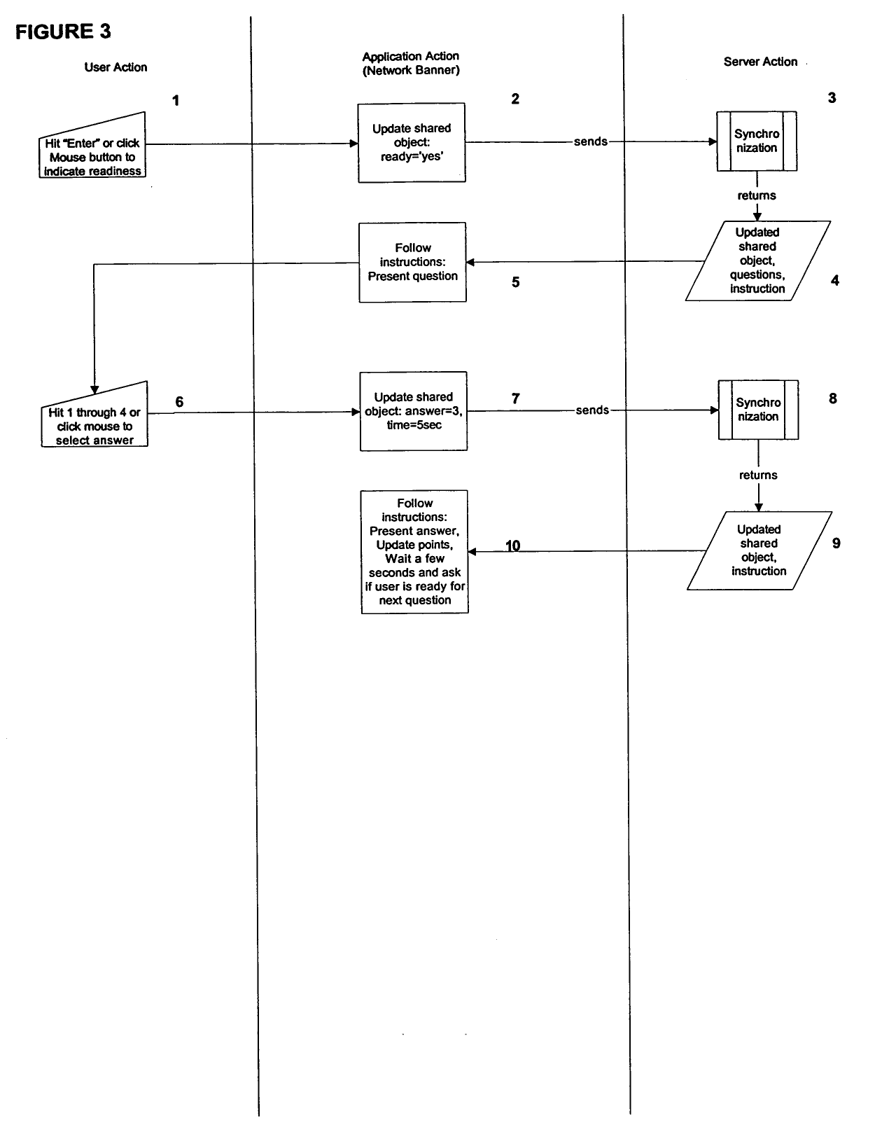

FIG. 3 is a depiction of how actions are taken by the individual actors within the functioning and use of the Network Banner. A User takes an action in step 1, which is provided to the Network Banner in step 2 which transmits the data to the synchronization server in step 3. The server updates information and performs any necessary calculations in step 4. It provides this data to the Network Banner in step 5 and then the user must respond to the new data in step 6. The new data is provided to the Network Banner in step 7, which in turn provides this data to the synchronization server in step 8, which synchronizes the data between users. The synchronization server updates data and performs any necessary calculations in step 9. This data again is presented to the Network Banners. This process continues until the function is over, e.g., the user quits the application.

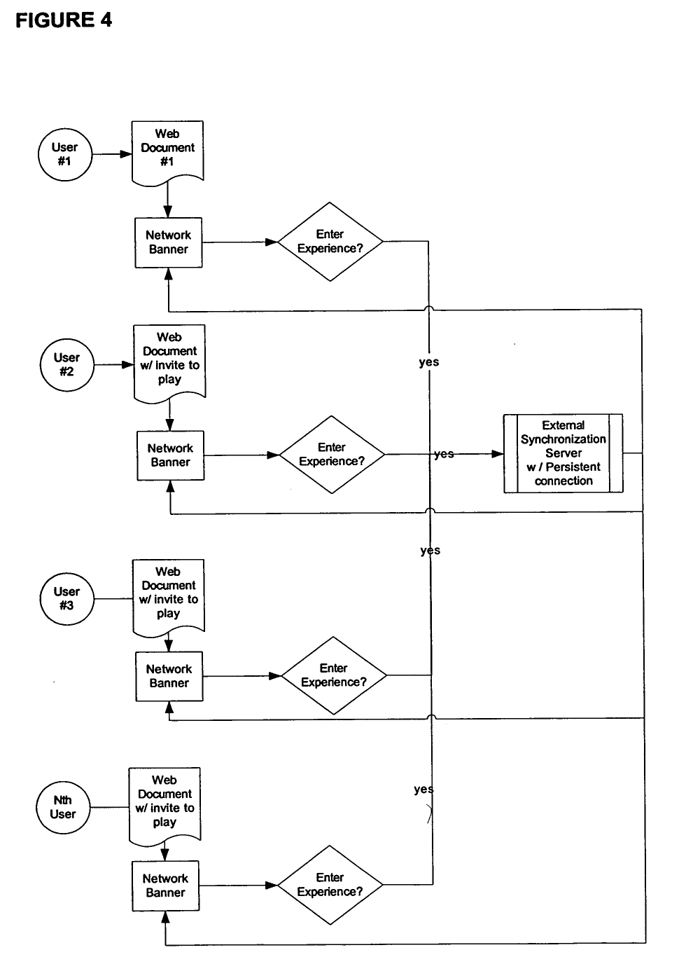

FIG. 4 is a depiction of a multiple user use of the Network Banners. Each user would pull up a web document which contains the Network Banner. Each of the four would have the opportunity to play. Each request to play would be sent to the synchronization server. Once each user elected to participate, the process would be the same as set forth in FIG. 1.

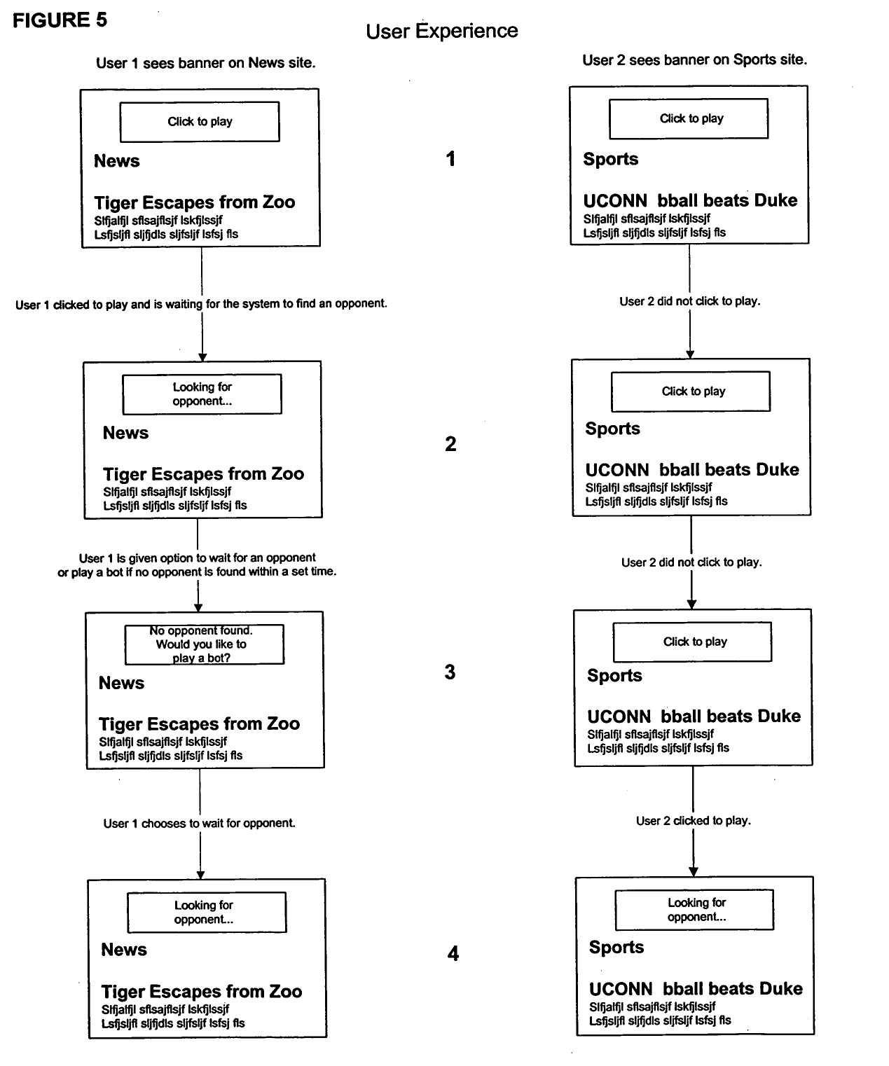

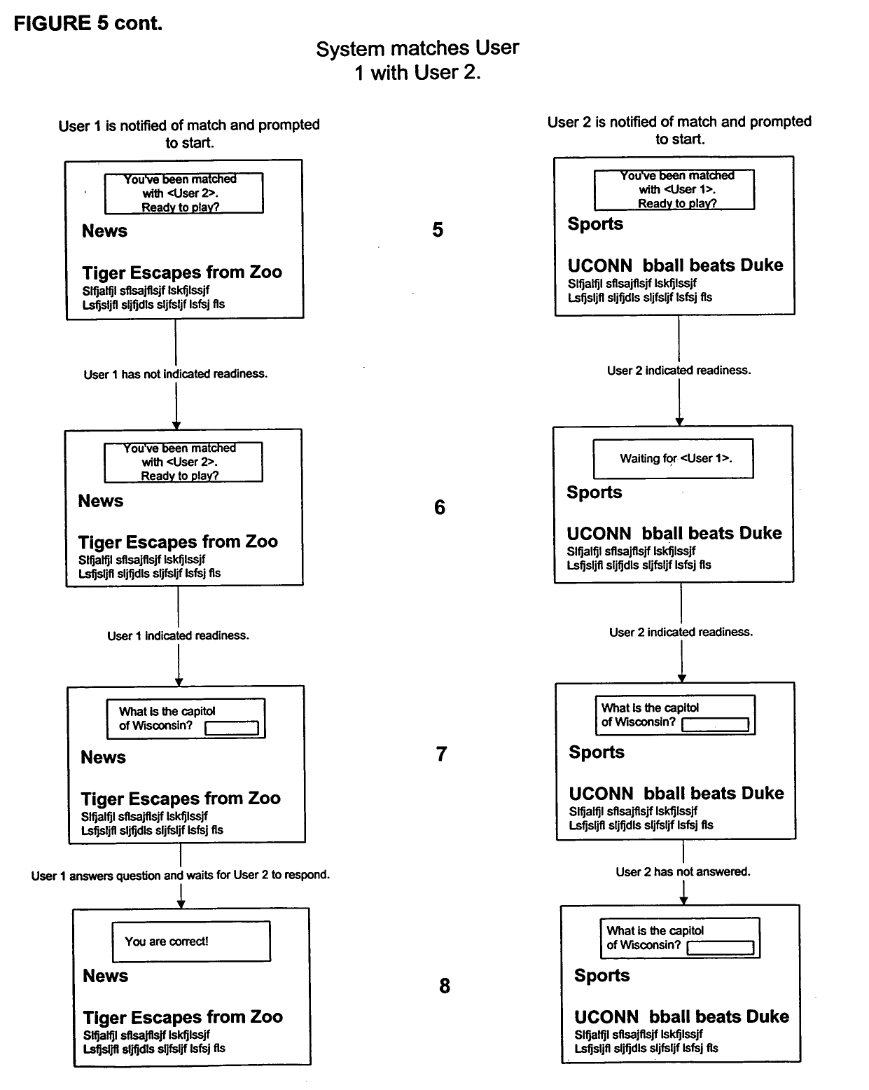

FIG. 5 depicts a user experience for a particular application of the Network Banners of a trivia game. Each User sees the same Network Banner in step 1. If User 1 opts to play, but User 2 does not, User 1 sees that the Network Banner is searching for a player in step 2. The Network may offer User 1 an opportunity to play a bot if there is not another user available against whom to play in step 3. If User 1 declines this offer, the Network Banner shows that it is searching for a player again and then in step 4 User 2 may select to play. Both players are presented with the match in step 5 and given the notice regarding readiness to play. If only User 2 indicates readiness, then in step 6, User 1 would be asked again if she is ready to play and User 2 would be told that they are waiting on User 1. When User 1 indicates readiness, the Network Banners would be synchronized and each would be presented simultaneously with the same question in step 7. If User 1 answers first, User 1 would be told she has the correct or incorrect answer in step 8. The Network Banner displays the updated information to each user. The game would continue with similar questions presented until a predetermined number of questions have been asked in which case the game would end.

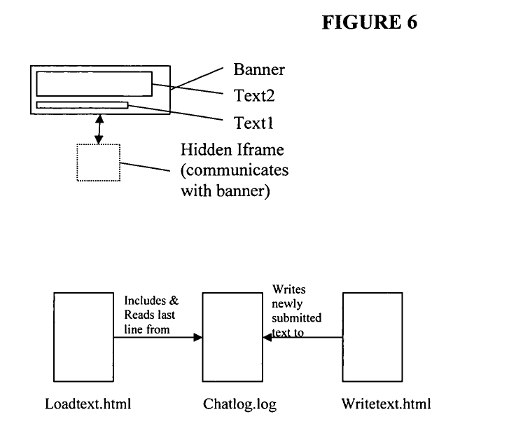

FIG. 6 is a depiction of the Chat Application example set forth below.

Examples

Tennis

Front-End

An example of this technology in use would be a simple tennis game. A user, viewing any web page, would see a banner ad within that web page that invites her to play a game of tennis one-on-one against another user. The user can accept the invite by pressing a button. If the user chooses to opt-in to the game, they are then presented with another screen that informs them with which other user they have been paired. When both users are ready, they enter the game without leaving the web page in which the banner is located.

In the game, within the banner the users will each see a player (representing each one of them) and the ball. The users can hit arrow keys or manipulate the mouse to move their players. When they want to hit the ball, they can hit the spacebar or click the mouse. A typical volley starts when player 1 hits the space bar and serves the ball. Player 2 will move into position to hit the ball back. As player 2 moves, player 1 sees where player 2 is on the court. Player 2 can also see where player 1 is on the court. Once in position, player 2 clicks his mouse to return the ball. Player 1 sees player 2's return and the change in direction of the ball. Player 1 moves and hits, player 2 returns, and so on.

Back-End/Logic

For this example, the entire experience may be built in Flash. The first banner ad consists of an invitation message within the banner and a button that (when clicked) indicates the user's willingness to opt-in to the game. Upon opting in, the Flash banner loads on to the user's computer another Flash movie. This Flash movie immediately connects to a server that allows persistent connections. For this example, any server running Flash Communication Server would function. This server is responsible for holding certain data (see below) and disseminating said data to connected users via their banners. Once disseminated, each banner being run by a user will interpret the data and react accordingly. One set of data held by the server is a listing (array) of all connected users. When the user initially connects, the server collects that user's data object and adds it to the list of all connected users. Each user's data object initially consists of information such as name, location, IP address, etc. After collection, the server then combs through the list of connected users and finds another user that has not been matched up with anyone else. The server then adjusts the data objects of these two users to indicate that they are paired (assignment of matching ids to each user's data object, placement of the two users' data objects into a new array, etc.). During game play, each user's data object will be constantly updated with information such as position on the court, points scored, and current action (hitting the ball or not). Because they are paired, the server will know that a user's data object must also be updated with information from their opponent's data object. A typical data flow would go as follows:

| | Application | | Application | What both |
|---|---|---|---|---|
| User Action | Action | Server Action | Action | users see |
| Player 1 hits | Player 1 app | Detect change in | Players 1, 2 app | Player 1 hits the |
| button (to serve | Detect button press | player 1 data object. | Detect update | ball |
| ball) | Change data object | Update both | to data object | |
| | (we will refer to as | players' data objects | Because | |
| | “users”) to indicate | to indicate player 1 | users[user1].hit = true, | |
| | hit action | hit action. | run hit1 | |
| | (users[user1].hit = true) | (users[user1].hit = true) | function | |
| | | Send update to | hit1 function - | |
| | | both users | animate player | |
| | | | 1 hitting ball | |
| Player 1 no | Player 1 app | Detect change in | Players 1, 2 app | Player 1 sees |
| action | Calculate angle and | player 1 data object. | Detect update | ball moving |
| | speed of previous | Update both | to data object | away |
| | hit action | players' data objects | Due to update | Player 2 sees |
| | Change data object | to indicate ball | in users[ball], | ball moving |
| | to indicate position, | position, speed and | run ball | closer |
| | speed and trajectory | trajectory. | function | |
| | of ball | Send update to | ball function - | |
| | (users[ball].x = 10, | both users | animate ball | |
| | users[ball].y = 30, | | movement | |
| | users[ball].angle = 3°, | | according to | |
| | users[ball.speed = 80 mph) | | position, speed | |
| | | | and trajectory | |
| Player 2 hits | Player 2 app | Detect change in | Players 1, 2 app | Player 2 moves |
| arrow keys to | Detect button press | player 2 data object. | Detect update | into position |
| move into | Change data object | Update both | to data object | |
| position | to indicate new | players' data objects | Because of | |
| | position | to indicate player 2 | update to | |
| | (users[user2].x = 40, | position. | users[user2].x, | |
| | users[user2].y = 50) | Send update to | run move2 | |
| | | both users | function | |
| | | | move2 | |
| | | | function - | |
| | | | animate player | |
| | | | 2 moving into | |
| | | | new position | |
| Player 2 hits | Detect button press | Detect change in | Players 1, 2 app | Player 2 returns |
| button (to return | Change data object | player 2 data object. | Detect update | the ball |
| ball) | to indicate hit action | Update both | to data object | |
| | (users[user2].hit = true) | players' data objects | Because | |
| | | to indicate player 2 | users[user2].hit = true, | |
| | | hit action. | run hit2 | |
| | | Send update to | function | |
| | | both users | hit2 function - | |
| | | | animate player | |
| | | | 2 hitting ball | |

Chat Application
Front-End

Another example of this invention in use would be a chat application, which is depicted in FIG. 6. This would be a simple banner within a web page that allows multiple users to communicate in real time. The user would opt in to participate in the chat. The banner would contain two html text fields (Text1 and Text2). The first text field (Text1) allows a user to enter text. The second text field (Text2) displays text. A user can type “hello world” into Text1 and hit the “Enter” key. Immediately, “hello world” appears in the Text2 for all users that are viewing the banner.

Back-End/Logic

Once a user goes to a web page with the banner, the banner immediately opens an iframe in a hidden DHTML layer. See FIG. 6. An iframe allows you to open an HTML page in a smaller area of a bigger HTML page. A DHTML layer allows you to put content on a page that can be positioned dynamically and hidden. The iframe will contain an HTML page (loadtext.html) that is set to refresh itself every five seconds. Upon refresh, loadtext.html receives the most recently submitted message from anyone viewing the chat banner. The page would run a JavaScript that checks if the most recently received message is in Text2. If so, it does nothing. If not, it adds the text to Text2.

When the user types a message into Text1 and hits “Enter”, the banner loads a new HTML page (writetext.html) into the iframe in the hidden DHTML layer. When loaded, writetext.html reads the message in Text1 and adds it to a file located on an external server (chatlog.log). Chatlog.log holds the full transcript of all messages entered into the chat banner. Writetext.html then loads loadtext.html into the iframe. Loadtext.html imports the most recently submitted message from chatlog.log via an include directive. Therefore, when every page that contains the banner reloads the hidden iframe, the message is sent to the banner. The user never leaves the original web page during this process.

1. A process for providing interactions between distinct internet users comprising:
a. providing via the internet to a computer an internet based publication in which is embedded a distinct network banner which comprises a user interface and executable coding enabling user data input and output;
b. said network banner communicating via the internet with a synchronization server capable of receiving and sending data to multiple users who have such a network banner; and
c. said synchronization server communicating via the internet with the same executable coding provided to a second, distinct computer.

2. A process according to claim 1 wherein the synchronization server is configured to maintain multiple persistent connections.

3. A process according to claim 1 wherein the network banner is coded in Flash.

4. A process according to claim 1 additionally comprising said synchronization server providing data provided by the first network banner to a network banner on a third, distinct computer.

5. A process according to claim 1 wherein each network banner is assigned a unique identification by the synchronization server.

6. A process according to claim 1 comprising an additional step of the synchronization matching computers on which the network banners have been loaded.

7. A network banner residing within a web page comprising:
a a banner user interface embedded in, but distinct from the web page user interface; and
b. the user interface containing executable software which enables the user to send and receive data from a synchronization server.

8. A network banner according to claim 7 wherein the network banner is coded in Flash.

9. A network banner according to claim 7 wherein the network banner is embedded within a distributed application.

10. A network banner according to claim 7 wherein the network banner includes a multi-player game.

11. A network banner according to claim 7 wherein the network banner is assigned a unique identifier by a synchronization server.

12. A network banner according to claim 11 which is matched with another network banner by the synchronization server.

13. A network banner according to claim 7 additionally comprising a second network banner embedded in another web page capable of sending and receiving data from the synchronization server.

14. An architecture for communicating in real time among different internet users comprising:
a. the same network banners loaded onto two or more different computers which computers are connected to the internet wherein the network banners are embedded within, but distinct from web pages distinct from the banners; and
b. a synchronization server connected to the internet capable of sending and receiving date from the network banners.

15. An architecture according to claim 14 wherein each network banner is assigned a unique identification.

16. An architecture according to claim 15 wherein the data among the network banners is synchronized by the synchronization server.

17. An architecture according to claim 14 wherein the network banners are encoded in Flash.

18. An architecture according to claim 14 wherein data entered through a network banner on one computer is transmitted via the synchronization server to a second network banner on a second computer.

19. An architecture according to claim 14 wherein therein are multiple synchronization servers.

20. An architecture according to claim 14 wherein three or more network banners are matched together by the synchronization server.
